(19) United States
(12) Patent Application Publication
(10) Pub. No.: US 2002/0025795 A1
(43) Pub. Date: Feb. 28, 2002

(54) Method, system and device for monitoring activity of a wireless communication device

(75) Inventors: Offer Sharon, Asseret (IL); Ran Bittmann, Tel Aviv (IL); Meir Lasry, Tel-Mond (IL)

Correspondence Address: BROWDY AND NEIMARK, P.L.L.C., 624 NINTH STREET, NW, SUITE 300, WASHINGTON, DC, 20001-5303, US

(73) Assignee: MSAFE INC.,, Wilimington, DE (US)

(21) Appl. No.: 09/917,212

(22) Filed: Jul. 30, 2001

Related U.S. Application Data
(63) Continuation-in-part of application No. 09/695,247, filed on Oct. 25, 2000.

(30) Foreign Application Priority Data
Aug. 24, 2000 (IL) 138056

(51) Int. Cl. H04M 11/00

(52) U.S. Cl. 455/405; 455/423

(57) ABSTRACT

A method, system and device for monitoring activity of a client wireless communication device (WCD), communicating through a communication medium is provided. A unit or device installed is as fitted onto said device monitors and records said activity and transmits it automatically, in a client non-controlled fashion, to an activity monitoring server utility.

### FIELD OF THE INVENTION

This invention relates to means for monitoring activity of a wireless communication device such as a communication device communicating through a cellular system. A particular application of the invention is monitoring activities, such as transactions, performed utilizing the communication device for the purpose of charging, or crediting a client account. An example of a monitored activity is access, through the communication infrastructure to a computer network, e.g. the Interned in, particular for the purchase of products, services, content or data from sites of the network. The monitored activity is subsequently used to charge a client account accordingly.

### BACKGROUND OF THE INVENTION

Wireless communication is likely the most rapid developing communication infrastructure. Wireless communication systems includes in particular cellular telephone and pager systems. Together with the rapid increase in use of cellular telephone systems throughout the world, the scope of use of cellular telephones is changing from a medium dedicated purely to voice communication, to a medium, used also for a wide variety of other applications. In particular, modern cellular telephones are installed with Internet access ability, making use of protocols such as the Wireless Application Protocol (WAP) developed therefor, while cellular telephone operators are beginning to provide a gateway through the cellular telephone networks to the Internet.

The Internet, in addition to being a medium for storing and retrieving information, is becoming a medium of choice for a wide variety of e-commerce transactions including purchasing of products for services, purchasing information, participating in gaming activity and others. The use of a cellular telephone for this purpose is advantageous in that each cellular telephone has a distinct I.D. and number, recognizable by the cellular telephone, operator, and thus the client performing a transaction can be easily identified for account billing purposes (or also for the purpose of crediting a client account, in the case, for example, of winning in a gaming activity).

Reference is made to FIG. 1, which is a schematic representation of one manner of carrying out a transaction through the Internet using a wireless communication device in accordance with the prior art. The wireless communication device 120, for example a cellular telephone, communicates with the Internet, represented as cloud 122, through a wireless communication 124. Data is transmitted from device 120 to the Internet 122 and back from Internet 122 to device 120 through the cellular telephone infrastructure 124. Switches 126, being Internet server utilities, intercept relevant transaction data together with the I.D. of device 120. Detail records (DRs) 130 are then transmitted to a charging gateway 132 located at the cellular system operator which then charges or credits the client's accounts, as the case may be. This continuous monitoring and data collection by switches 226, is a major cause for degradation in performance, as it limits the rate of operation and billing.

Another manner of performing a transaction using a wireless communication device in accordance with the prior art can be seen in FIG. 2. In FIG. 2, like reference numerals to those of FIG. 1 are used, shifted by 100, to denote components having the same function (and the reader is referred to the description of FIG. 1 for explanation). Also in this prior art embodiment, in order for the operator to bill for the transactions, accounting information in the from of DRs 230 needs to be collected. In this case, in order to reduce the load from switches 226, data probes 236 are installed which probe all data intercepted by switches 226 and send this data as DRs 230 to a charging gateway 232 located at the cellular telephone operator. This solution requires to install many probes 236 that need to be as fast as Internet switches 226 and to be regularly updated with the newest protocol standards whenever such are released. The charging gateway 232 correlates this data to device 222, which is a relatively cumbersome procedure as data from even a single transaction may proceed through several DRs paths. This provides a limit to the operator's billing options and to the growth of its network.

PCT Application, Publication No. WO 98/47116, discloses a teledata communication network which facilitates payments between a customer account to a merchant account. A service node is provided which acquires a merchant identifier and the transaction amount from the customer mobile communication device and then sends the transaction verification request message to both the customer mobile station and the merchant terminal. Upon receipt of the transaction verification, the service node requests the transfer of the transaction amount from the customer account to the merchant account.

European Patent Application No. 940783, discloses a mobile electronic payment terminal to which a standard mobile communication device, for example, a cellular telephone, may be connected to enable full mobile electronic finds transfer at point of sale transactions to occur. The payment terminal kept at the point of sale location can receive and accommodate the cellular telephone in order to perform a transaction.

The continuous rapid increase in the number of users of cellular telephone systems, the growing complexity of the system and the increased diversity in the type of services provided to users, growing diversity ill the type of quality of service provided to different users, such as location based services and increasing complexity and diversity of billing schemes (for example, content-based billing, third party billing, etc.) presents challenges which are extremely difficult to overcome in current cellular telephone systems. In addition to huge technical difficulties in designing and installing billing systems to suit modern use of cellular telephone systems, the manner of design of thee current systems makes scalability a very difficult problem. One possible solution is to channel all communication traffic trough a single activity-monitoring node. This however causes a very serious bottle neck in the system. Furthermore, a system that monitors activity of a large number of users in a single node is extremely expensive to install.

### SUMMARY OF THE INVENTION

The invention provides a novel method, system and device for conveniently monitoring the activity of a wireless communication device (WCD). In accordance with the invention, the WCD comprises a unit, which may be a hardware device, a software utility or a combination of the two and which probes, records and stores data relating to activity performed by a client's WCD. Such activity includes, for example: use of the wireless communication network in general, e.g. communication time or utilized bandwidth; utilization of special services, eg. access to a computer network such as the Internet, to which a gateway is provided by the wireless communication service provider (to be referred to herein as the “service provider”) access of specific sites of the computer network that require payment for such access; purchase of products, services, content or data from sites of the computer network; payment made to the client, for example, in case of a win in a network gaming activity; etc. This activity data may be pulled by an activity-monitoring said server utility or of the activity data periodically pushed to said server utility by said unit. The transmission may be according to a configurable set of rules defined by the service provider or by a content provider, e.g. an Internet service provider.

The invention thus provides, by one of its aspects, a method for monitoring activity of a client wireless communication device (WCD). In accordance with this method, an activity-monitoring unit is installed in or connected to the WCD. The activity-monitoring unit can record communication activity of said WCD which is carried out over a wireless communication infrastructure of a wireless communication system and generate an activity data record based thereon. Then, in a client non-controlled (and preferably non-controllable) communication session, the activity data record is transmitted through the wireless communication infrastructure to an activity-monitoring server utility of the communication system.

In accordance with another aspect the invention provides a method for monitoring communication activity of WCDs of clients of a wireless communication system. In this method WCDs having each or being connected each to an individual activity-monitoring unit of the kind specified are provided to clients, or alternatively, such units are installed or connected to existing WCDs. The communication system is provided with an activity-monitoring server utility such that the server utility and the WCD can communicate, in a client non-controlled communication session over the wireless communication infrastructure to permit the transmission of the activity data record from said unit to said server utility.

The invention also provides, by an additional aspect, a method for managing an account of a client of a wireless communication system, which account is being billed or credited based on communication activity of a client WCD over the wireless communication infrastructure. Client WCDs are provided that, a priori, have an activity-monitoring unit of the kind specified above or all existing client WCD is installed with or connected to such a unit. An activity-monitoring server utility of the system communicates with the unit over the wireless communication infrastructure such that said activity data record is transmitted from said unit to said server utility The client account is then billed or credited based on the activity data.

In accordance with one embodiment of the latter method, the invention provides a method for carrying out a transaction over a computer network. The transaction may, for example, be purchasing a product, service, data or content. In this preferred embodiment, a client through a client WCD, communicates with the computer network over the wireless communication infrastructure, via a gateway provided by the communication infrastructure and initiates the transaction. An activity monitoring unit that is included with or connected to the WCD records the particulars of the transaction and generates an activity data record. In a client non-controlled communication session, said activity data record is then transmitted over the wireless communication infrastructure to the activity-monitoring server utility. Based on this transaction data record, the client account is debited or credited and the account of the transaction part (for example the account of the provider of the product, service, data or content) is respectively credited or debited.

The invention still further provides, by a further of its aspects, a wireless communication system, comprising a wireless communication infrastructure and client wireless communication devices (WCDs) communicating through said infrastructure. Activity-monitoring units of the kind specified above are included within or are connected to at least some of said WCDs, each such unit recording and storing activity of the WCD in which it is installed or to which it is connected to generate an activity data record. The system includes a server utility for recording communication activity of the WCDs. Said unit and said server utility can enter into a client non-controllable communication session over said communication infrastructure to transmit said activity data record to said server utility.

Also provided by the invention, in yet another of its aspects, a client wireless communication device (WCD) that permits a client to communicate over a wireless communication infrastructure, and having or being connected to an activity monitoring unit that records communication activity of the WCD and generates an activity data record corresponding to said communication activity. Said WCD can enter into a client non-controllable communication session, over the wireless communication infrastructure, with the activity-monitoring server utility of the wireless communication system to transmit said data record to said server utility.

By yet a further aspect the invention provides a device for installing in or connecting to a client WCD, the device comprising a unit that records communication activity of the WCD to generate an activity data record of such activity. Said unit can transmit said data record in a client-non-controllable communication session, over said communication infrastructure, to an activity-monitoring server utility of the wireless communication system.

### DETAILED DESCRIPTION OF THE INVENTION

The present invention is applicable to a wide variety of wireless communication systems. The invention is, however, particularly applicable for cellular communication systems, which are today the fastest growing communication infrastructures. At times the invention will be described with reference to the preferred embodiment of a cellular communication system, it being understood the invention is not limited thereto but applies more broadly to wireless communication systems in general, such as, for example, a one-way or two-way paging system.

The term “communication infrastructure” used below includes all the components of a communication system involved in the provision of communication service to the WCD. In the case of cellular telephone, these include the base stations of the various cells, a cellular telephone switching office that handles all the phone connections of cell phones which communicate with the base stations linked to the cellular telephone switching office, a central control system that coordinates activities of all central offices, etc.

The invention provides a novel solution to the problem of monitoring the communication activity of the client WCD. In accordance with the invention, rather than continuously monitoring the communication activity of clients by utilizing central system resources, the activity, is recorded by an activity-monitoring unit which is installed in the client WCD. In a way, the WCD-associated activity-monitoring unit is an extension of the central activity-monitoring server utility of the system. In this way, the activity-monitoring solution provided by the invention requires considerably less system resources than existing, prior art activity-monitoring solutions, such as those described above. Through this unique solution, the invention, for one, allows to easily correlate between a certain client (or his WCD) and the communication activity performed by him, an extremely difficult endeavor in existing communication systems. The difficulties in monitoring the communication activity and correlating each with a specific client, is particularly an issue in existing cellular telephone systems as the client moves from one cell to another throughout a communication session. Furthermore, a system scale-up, in accordance with the invention, is easier than prior art communication activity-monitoring systems, as the scale-up, in accordance with the invention, requires a far less system upgrade and scale-up, as compared to prior art systems. This is s particularly important for billing systems which are based on transmitted data packets or transmitted or received content, which is a highly complex endeavor in current systems.

The activity-monitoring solution in accordance with the invention, permits the monitoring ad recording of the actual communication activity, including the actual communication service received by the client WCD, and thus permits to base billing on a variety of factors, not hitherto possible, that depend on such actual communication activity. For example, the invention permits to base billing on factors such as quality of service, e.g. the actual bandwidth allocated to a client at a particular time, avoid billing a client in the case of a disrupted communication session. Additionally, by remote setup of the activity-monitoring unit, individualized billing schemes are facilitated.

The WCD may be any wireless appliance, such as a client end unit of cellular communication network, e.g. a cellular telephone, a computerized device with a cellular modem, a cellular video phone, etc. In general, as will no doubt be appreciated by the artisan, the WCD may be any device having the ability to communicate over a wireless communication infrastructure, with a cellular communication infrastructure being a particular preferred embodiment, as already mentioned above.

The activity-monitoring unit may be installed within the WCD or may be connected thereto. For example, the WCD may be incorporated within the cellular modem.

The activity-monitoring unit may be used for monitoring different kinds of activities performed by the WCD. The activity-monitoring unit is a logical unit that can be either be a hardware device or a software utility with either dedicated hardware resources, dedicated software resources or both.

The activity recorded may be the extent of use of tie WCD, the extent of communication traffic with the WCD, e.g. the number of data packets transmitted to the WCD. For example, in accordance with one embodiment applicable in the case of a cellular telephone network is data may be collected and thereafter the activity data transmitted to the monitoring server utility may then serve to bill the client for the “air time” utilized by the client with his WCD.

In accordance with another embodiment the recorded activity may be usage of a computerized network accessed through the communication infrastructure (through a gateway provided by the server provider (SP)), the computerized network being typically, although not exclusively, the Internet. The computerized network may also be, for example, an intranet or an extranet. The activity recorded may be, for example: the time spent navigating through the network for charging the client based on such time access by the client to sites of the network which require payment for access; the amount of bits (or bytes) or data packets transmitted to or from the WCD for a bill-by-bit (or bill-by-byte) or bill-by-data packets charging basis; the type of network-enabled service used by the “WCD for charging the client on that basis; the bandwidth used for a specific activity, particularly where the bandwidth is controllable, for charging a client on the basis thereof; etc.

By another embodiment, the recorded activity may be transactions performed by the client, e.g. purchase of a product, service, data or content, within the computer network, through the use of his WCD. Transactions of this kind performed using a mobile communication unit are often referred to in the ant as “mCommerce”, Such an activity record may then be used to bill the client for the transactions. The transactions-related activity record, transmitted to the activity monitoring server utility creates a transaction activity record for which the client may be charged directly by the SP. The activity monitoring server utility may thus serve in this case as a billing agent. The transaction charges may appear as a separate charge item in the periodical billing charges sent by the SP to the client. This is a new way of billing for transaction facilitated by the invention, which may replace the direct billing to a client account in a financial institution, e.g. to a credit card account, as in the prior art. However, the latter form of billing is also possible in accordance with the invention: the activity monitoring server utility may also transmit the transaction or direct accounting (charging or crediting) data (the latter construed based on the activity data) to such a financial institution/client account.

In accordance with another embodiment, the recorded activity may be a certain transaction which is billed to a third party. For example, occasionally a message is broadcasted to a plurality of cellular clients, for example, based on a specific client profile, and a third party is charged based on the number of clients that receive the broadcast. This may be the case, for example, where a service or product provider wishes to broadcast an advertisement relating to his provided services or product, respectively, with the charge being based on the number of actual cellular telephone users who received the advertisement. This is very difficult to do in current systems as the actual reception of a specific message depends on a variety of factors which cannot be effectively monitored centrally.

The transmission of the activity data to the activity monitoring server utility is performed automatically in a manner not controlled by a client. This ensures the integrity of activity data transfer to the server utility. Such transmission may be in a communication session initiated by said server utility, typically at time periods in which the wireless communication infrastructure is less busy, namely at off-peak periods. By another embodiment of the invention, the transmission may periodically be initiated by the activity recording unit, e.g. automatically after passage of a predefined time or according to a predefined set of rules or alternatively when said unit senses an off-peak period. The exchange of data between said unit and said server utility may involve standard handshake protocols and will typically be in an encrypted form. The transmission protocols and method of encryption that are used may be such that are known per- se and are thus readily available to a person versed in the art.

The term “activity-monitoring server utility” should be understood in the functional sense, namely as hardware/software combination that performs the functions as defined and explained herein. Said server utility may be comprised of one or more independent servers; or may be comprised within or integrated with the system of the SP; etc. Said server utility may be linked to an independent modem unit that communicates with all the activity-monitoring units within the WCDs through the communication infrastructure; or its communication interface may be integrated with the communication system infrastructure. As may readily be appreciated to the artisan, the invention is not restricted to any specific system architecture and any system having functions such as these defined and described above and bellow, is within the scope of the invention.

After transmission of information, the server utility may debit mid transfer the money, for example, from a client to a merchant account, or in another case credit a client account. The client account may for example be a client account with the SP; or may be a credit or debit card account or another form of a client account in a financial institution, the details of which were a priori obtained for the specific client, in which case the server utility transits the transaction data to the financial institution for debiting or crediting the clients account there. The server utility obviously also has data on the other party of the transaction and initiates payment to or from such other party.

Performing transactions over a computer network is a specific embodiment of the invention. In accordance with this embodiment the unit of the WCD records particulars of the transaction and generates a transaction data record. This transaction data record is then utilized in order to debit or credit the client account, based on the type of transaction and, respectively, credit or debit the account of the party to the transaction which may be the provider of the service, product, data or other content. Generally,. the transaction in accordance with this embodiment may be any type of mCommerce.

In accordance with one embodiment of the invention, the server utility can through communication with said WCD over the wireless communication infrastructure, set up or program said unit. For example, the unit may be set up to define a price structure or plan for a specific activity, a primary arrangement generally applicable or a specific one for the specific client, etc. The set-ups may include, for example, set-up for time of day—dependent billing, service level agreement, quality of service set-up price structures a content-based price structure, etc.

The activity monitoring unit typically comprises a data encryption module, for example an asymmetric data encryption standard accelerator for boosting performance of public key infrastructure (PKI) and secure a connection handshake and sign a document or certificate or for example a symmetric data encryption standard for accelerating secure (encrypted) data transmission between the unit and the said server utility. Asymmetric data encryption standard accelerators include, for example, elliptic curve cryptography (ECC) accelerator, Rivest, Shamir and Adleman (RSA) accelerator, a Diffie-Helman (DH) accelerator, a multi-prime (MP) accelerator, and others. Symmetric data encryption standard accelerators are for example Data Encryption Standard (DES) accelerator, Advanced Encryption Standard (AES) accelerator that may be used in accordance with the invention and Secure Hash Algorithm 1 (SHA-1) accelerator.

The activity-monitoring unit may also comprise one or more real time clocks.

The WCD or said activity-monitoring unit may include safety features intended to block the ability to tamper with the device or with the automatic transmission feature, so as to ensure integrity of the activity data transmitted to said server utility.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 shows one example of a prior art activity monitoring system.

FIG. 2 shows another example of the prior art activity monitoring system.

FIG. 3 shows a system in accordance with an embodiment of the invention.

FIG. 4 is a schematic representation of a WCD in accordance with an embodiment of the invention.

FIG. 5A is a schematic representation of another embodiment of a WCD in accordance with the invention.

FIG. 5B is a schematic representation of a further embodiment of a WCD in accordance with the invention.

FIG. 6 is a schematic representation of an activity-monitoring unit in accordance with air embodiment of the invention.

FIG. 7 is a schematic representation of a software design operable in said unit, in accordance with an embodiment of the invention.

FIG. 8 shows another embodiment of the activity-monitoring unit.

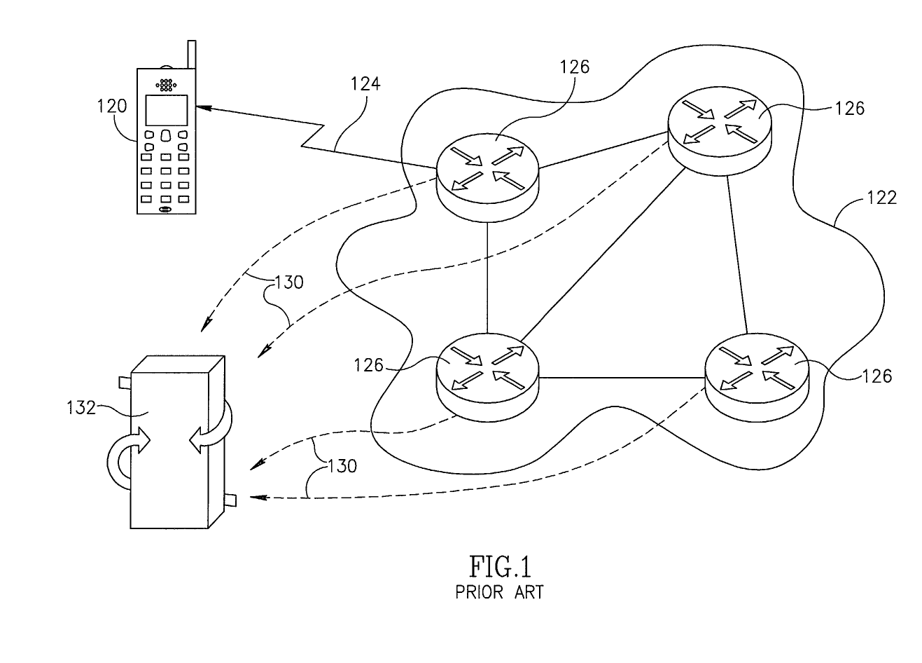

### DETAILED DESCRIPTION OF SPECIFIC EMBODIMENTS

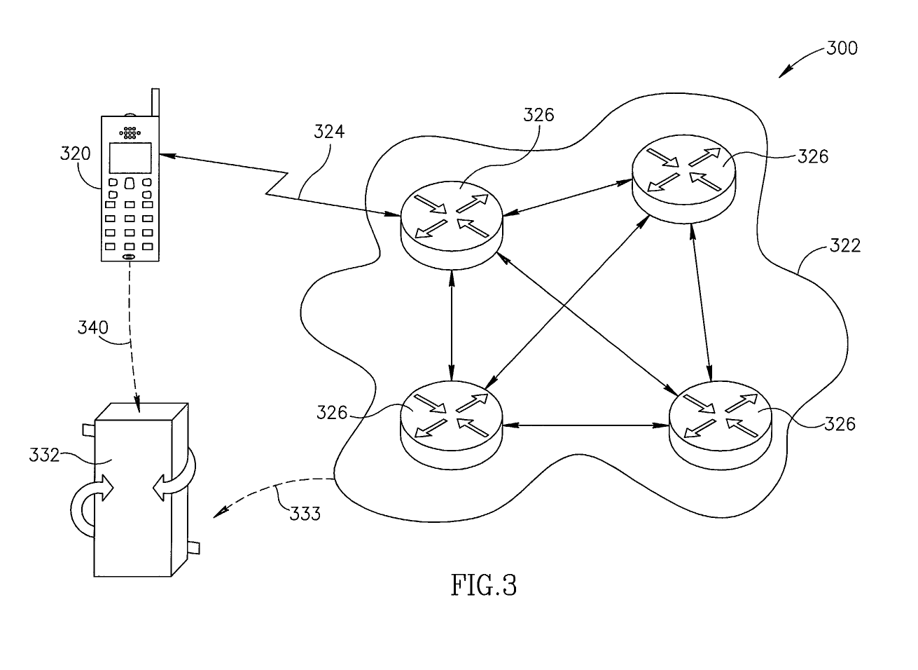

Reference is made in FIG. 3 showing a schematic representation of a design of a system generally designated 300 in accordance with an embodiment of the invention. In this embodiment, the communication infrastructure is a cellular network infrastructure, although it will be appreciated that this is an example and the invention is not limited thereto. The invention will be described in the following in reference to a cellular network as the wireless communication infrastructure, with an understanding that the description is applicable, mutatis mutandis to other wireless communication media.

The system 300 includes a cellular telephone infrastructure, represented, for the sake of simplicity, by means of bi-directional split arrow 324. A cellular network may be a standard cellular network, as known per se, supporting wireless communication of a plurality of user with wireless communication devices, such as cellular telephone device 320. It will be appreciated that the cellular telephone is an example only and the invention is applicable also to other type of communication devices equipped with a communication interface such as a modem, an ethernet connection module, etc. permitting them to transmit and receive data, video or voice over a wireless network medium. The communication device 320 has incorporated therein an activity-monitoring unit (not shown in FIG. 3) which tracks activity by device 320. Such a monitoring activity may be air-time usage, access to computer network, e.g. the Internet, entry of charging sites within computer network, transactions performed using the device 320, and others. In a preferred embodiment, the monitored activity constitutes transactions performed by device 320 within Internet 322 accessible through cellular communication network 324.

When accessing Internet 322, through a gateway provided by the cellular network 324, the device scads and receives data. The activity, in particular transactions performed within the Internet, for example purchase of a product or service, retrieving of information which requires payment, etc., is then recorded by the activity monitoring unit within device 320 and temporarily stored therein. The activity data is occasionally transmitted through the cellular network, represented by broken line 340, to an activity monitoring server utility 332, e.g. a charging gateway. The server utility 332 may be an independent unit communicating with devices 320 through the cellular network, although it is preferably a utility associated with or incorporated within the communication service operator. The transmitted activity data 340 may be a single record or may be multiple records, e.g. records relating to a plurality of transactions. Accumulating records over a period of time and sending of accumulated records only periodically, is a preferred embodiment of the invention.

The transmission of the activity data 340 may typically involve a handshake communication protocol and will preferably be encrypted. Furthermore, such transmission is automatic and in a manner not controllable by the client to assure integrity of transmitted activity data. It should be noted that server utility may itself be linked to the Internet, as represented by broken lines 333, for example, for the purpose of transmitting account data through the Internet to a financial institution holding a client account.

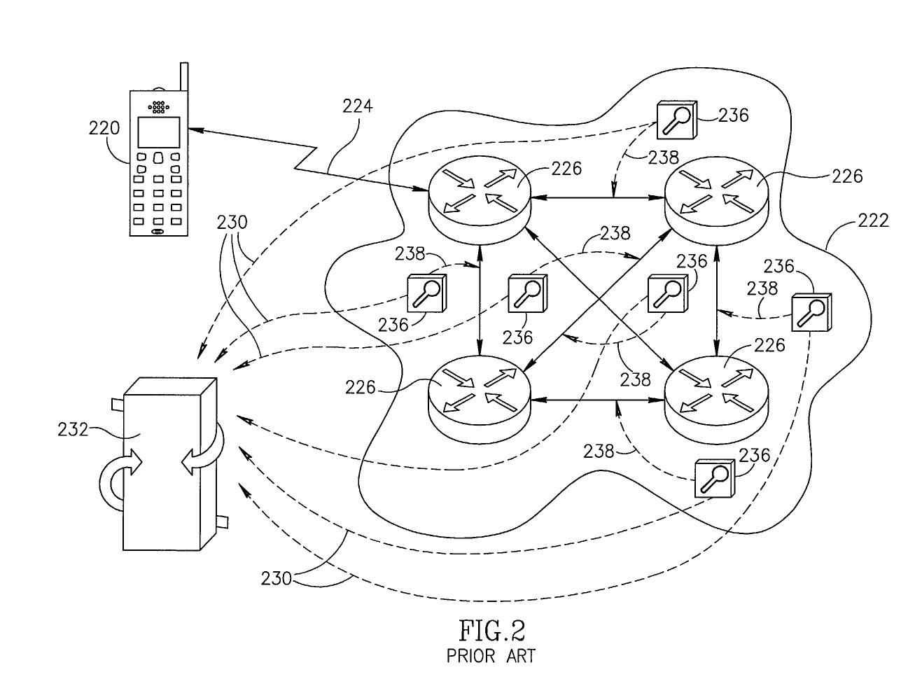

In accordance with the invention, DRs transmission from switches 326 or probes (see FIG. 2) is not required. This considerably reduces the load from, switches 326 should the switches be probed as in accordance with the prior art.

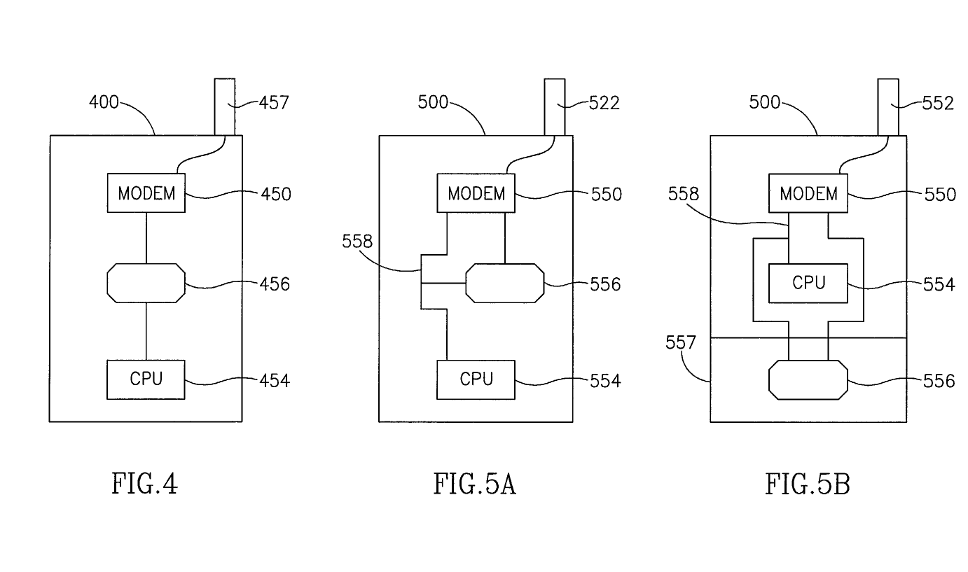

Reference is now being made to FIG. 4 showing a schematic representation of a wireless communication device in accordance with an embodiment of the invention. The illustration of FIG. 4, as well as that of FIG. 5, are in fact logical representations. While tee device is illustrated here as being comprised as several independent modules, in reality, while this may be the case, it is also possible to incorporate these independent modules into a single integrated circuit or unit. The text relating to FIGS. 4 and 5 should thus be read in this context.

Device 400 illustrated in FIG. 4, comprises, similar to prior art devices, a modem 450, linked to an antenna 452, and a central processing unit (CPU) 454. (Similarly as in the case of the prior at device 400 comprises a user interface, e.g. a keyboard and display (not shown herein). In accordance with the invention communication device 400 comprises also an activity monitoring unit 456 linking between CPU 454 and modem 450. In this manner, unit 456 monitors and records activity of device 400.

Another embodiment of a device 500 in accordance with the invention is shown in FIG. 5A. In this case, activity-monitoring unit 556 is linked to the BUS 558, linking CPU 554 to modem 550 and can thereby monitor and record the activity of device 500. Unit 556 is also linked to a modem 550 in a manner permitting it to occasionally transmit stored activity data, through the cellular communication infrastructure, to server utility 332 (see FIG. 3).

FIG. 5B shows a further embodiment in accordance with the invention. This embodiment is very similar to that shown in FIG. 5A and functionally like components were given like reference numerals to the corresponding components in. FIG. 5A, The main difference in this embodiment is that the activity monitoring unit 556 is included within the framework of an independent auxiliary device 557 which is connected to the WCD 500. Such an auxiliary device should, preferably, be made to be tempering-proof.

The transmission of activity data between units 456, 556 to the server utility may be pulled by the activity monitoring server utility namely in a communication session initiated by said server utility, or alternatively, unit 456, 556 may be programmed to occasionally, e.g. after a defined period of time, after a certain billable activity has been carried out, e.g. when the flash memory (see below) has been filled, etc.

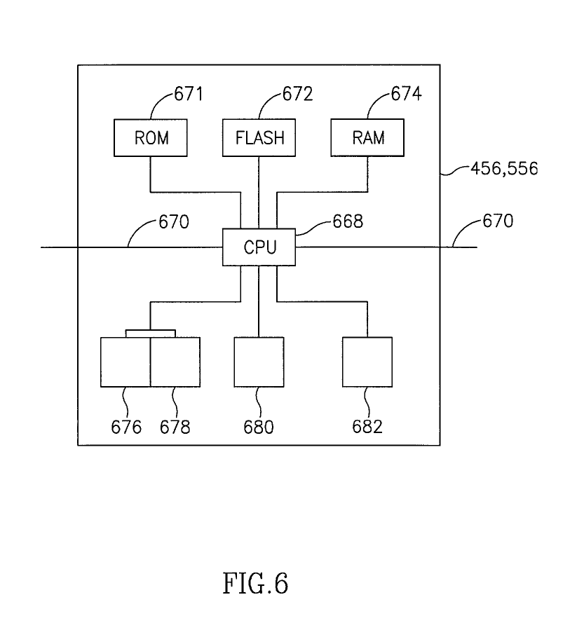

FIG. 6 shows a schematic representation of the structure of the activity-monitoring unit 456, 556. This unit comprises a CPU 668, linked through links 670 to the CPU and the modern. The unit comprises three memories including a read only memory (ROM) 671, a flash memory 672 and a random excess memory (RAM) 674. The ROM is used to store the code section for the CPU's operation, is responsible for initial boot strap procedure, and may also include a code for upgrade procedures and others.

Flash memory 672 is dedicated to maintaining user configuration, e.g. configuration of the unit transmitted thereto from the operator. In addition, the flash memory records and stores the activity data that is to be transmitted at a later stage to the activity recording program server utility. Furthermore the flash memory stores also part of the code of the device, mainly the part of the code that may be upgraded.

The RAM is used, as known per se, to hold intermediate data needed for the CPU's operation.

Device 456, 556 may also comprise encryption modules such as for example an elliptic curve cryptography (ECC) accelerator 676 for boosting performance of the public key infrastructure and secure a connection handshake; as well as a data encryption standard (DES) accelerator 678 for boosting performance of the data transfer which is based on symmetric keys.

Also included in device 456, 556 is a random key generator 680 that can produce a seed typically having a cycle of not less than 1,024 bits, as well as a timer 682, for example a 32-bit real time clock.

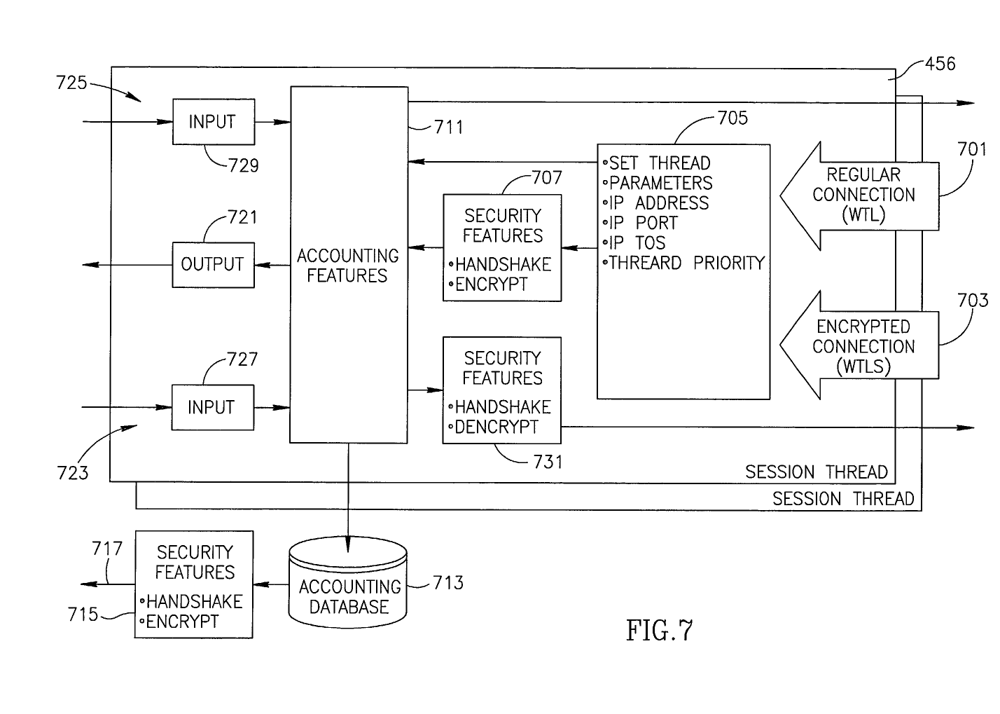

Reference is now being made to FIG. 7, illustrating the flow of activity data of multiple sessions through wit 456, 556. The data can flow from the modem (not shown) of the wireless communication device either through a regular wireless transport layer (WTL) channel 701 or through a wireless transport layer security connection channel 703. The data then flows through a configuration filter 705 setting the quality of service and addressing parameters. In case of an encrypted connection the data then flows through a security filter 707 that performs the handshake and hashing protocol required for a secure session, The data, either directly in the case of a regular connection or via the security filter 707 in case of a secure connection passes through an accounting filter 711 that monitors the data and inserts it into an accounting database 713. The data is transmitted, typically through an output security filter 715 through the wireless communication infrastructure 717 to the activity monitoring server utility. The input data then transfers, through interface 721 to the modem of the device (not shown).

Data in the reverse direction transfers through either a secure channel 723 or a regular channel 725 via interface 7Z7,729, respectively, through accounting filter 711 and then out, in case of a secure connection through input security filter 731 to the CPU (not shown).

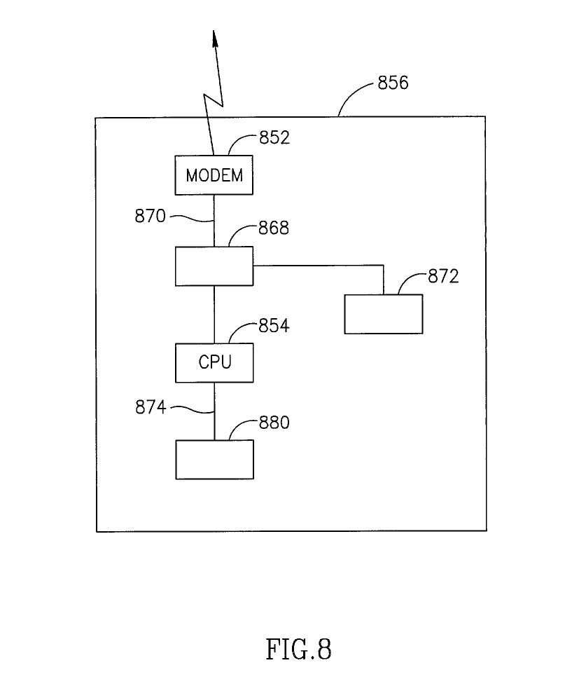

Reference is now being made to FIG. 8 showing another embodiment of the activity-monitoring unit. The activity-monitoring unit 856 comprises a software application (code) 868 linked through links 870 and 872 to a CPU 854 and modem 852, respectively. The unit comprises also a dedicated flash memory 872. Flash memory 872 maintains user configuration, for example, user configuration transmitted to the WCD from the operator. In addition, the flash memory records and stores the activity data that is to be transmitted at a later stage to the activity recording server utility of the SP. The flash memory may be a dedicated part of the WCD flash memory or may be a stand alone flash memory. Security features are imparted by the security unit 880 through its link 874 to tho CPU 854.

1. A method for monitoring activity of a client wireless communication device (WCD) comprising:
(a) installing in or connection said WCD to an activity-monitoring unit that can record communication activity of said WCD, carried out over a wireless communication infrastructure of a wireless communication system and generate an activity data record; and
(b) in a client non-control communication session, transmitting said activity data record, through said wireless communication infrastructure, to an activity monitoring server utility of said communication system.

2. A method according to claim 1, wherein said WCD is a client end unit of a cellular communication network.

3. A method according to claim 1, wherein said activity comprises usage of a computer network accessible through said communication infrastructure.

4. A method according to claim 3, wherein the computer network is the Internet, an intranet or an extranet

5. A method according to ay one of claims 1-4, comprising:
(c) debiting or crediting a client account based on said activity data record.

6. A method for monitoring communication activity of wireless communication devices of clients of a wireless communication system, comprising:
(a) providing WCDs having each or being connected each to an individual activity-monitoring unit or installing or connecting individual activity-monitoring units to existing WCDs, the activity-monitoring unit can record communication activity of the WCD in which it is incorporated or to which it is connected that is carried out over a wireless communication infrastructure over a wireless communication system, and generates an activity data record; and
(b) providing the communication system with an activity-monitoring server utility, said server utility and said WCDs can communicate, in a client non-controlled communication session, over the wireless communication infrastructure, to transmit the generated activity data record from said units to said server utility.

7. A method according to claim 6, wherein said WCD is a client end unit of a cellular communication network.

8. A method according to claim 6, wherein said activity comprises usage of a computer network accessible through said communication infrastructure.

9. A method according to claim 6, wherein the recorded activity comprises one or more of the group consisting of communication time, transmitted data packets, received data and received content.

10. A method for managing an account of a client of a wireless communication system, the account being billed or credited based on communication activity of a client WCD over a wireless communication infrastructure of the system, the method comprising:
(a) providing the client with a WCD having or being connected to an individual activity-monitoring unit, or installing an activity-monitoring unit in existing client WCD, said unit can record communication activity of said WCD carried out over the wireless communication infrastructure and generate an activity data record;
(b) providing said communication system with an activity-monitoring server utility, said server utility and said WCD can communicate over the wireless communication infrastructure to transmit said activity data record from said unit to said server utility; and
(c) billing or crediting client account based on the activity data.

11. A method according to claim 10, wherein the recorded activity comprises a transaction performed through the user of the said WCD within a computer network, trough a gateway provided by the wire communication infrastructure.

12. A method for carrying out a transaction over a computer network, comprising:
(a) a client through a client WCD, communicating with the computer network over a wireless communication infrastructure of a wireless communication system and via a gateway provided by the communication system and initiating the transaction;
(b) an activity-monitoring unit included within or connected to said WCD, recording particulars of said transaction and generating a transaction data record;
(c) through a client non-controlled communication session, transmitting said activity data record, over the wire communication infrastructure, to an activity-monitoring server utility; and
(d) based on said transaction data record, debiting or crediting a client account and respectively crediting or debiting an account of a transaction party.

13. A method according to claim 12, wherein said computer network is the Internet.

14. A method according to claim 12, wherein said transaction comprises purchasing a product, service or information from one or more sites of the network and said activity data record comprises data on the purchase costs of said product service or information.

15. A method according to claim 12, wherein said transaction comprises crediting the client with a value, said data record comprises data on said value.

16. A method according to claim 15, comprising: crediting a client's account with said value based on said data file.

17. A wireless communication system, comprising:
a wireless communication infrastructure and client wireless communication devices (WCDs) communicating through said infrastructure;
an activity monitoring server utility for recording activity of the WCDs; and
activity monitoring units being included within or being connected to at least some of said WCDs, each unit recording and storing activity of the WCD in which it is installed or to which it is connected to generate an activity data record; said unit and said server utility can enter into a client non-controllable communication session over said communication infrastructure to transmit said activity data record to said server utility.

18. A wireless communication system according to claim 17, wherein the communication session between said unit and said server utility is in a secure mode.

19. A wireless communication system according to claim 17, wherein said communication session is initiated by the server utility.

20. A wireless communication system according to claim 17, wherein said communication session is initiated by either the server utility or said unit at off-peak periods of usage of the wireless communication infrastructure.

21. A wireless communication system according to claim 17 wherein said server utility can control the set-up of one or more modules within said unit.

22. A client wireless communication device (WCD), permitting a client to communicate over a wireless communication infrastructure, said WCD having or being connected to an activity monitoring unit that records communication activity of the WCD to generate an activity data record; said WCD being capable of entering into a client non-controllable communication session, over the wireless communication infrastructure, with an activity-monitoring server utility of a wireless communication system to transmit said data record to said server utility.

23. A WCD according to claim 22, wherein said WCD is a mobile phone or a personal digital assistant (PDA) and said communication infrastructure is a cellular network.

24. A mobile phone or a PDA according to claim 23, being configured such so it can link through the cellular network to the Internet.

25. A device for installing in or connecting to a client wireless communication device (WCD), the device comprising a unit that records communication activity of the WCD to generate an activity data record; said unit being capable of transmitting in a client non-controllable communication session over said communication infrastructure, said data file to an activity-monitoring server utility of a wireless communication system.

26. A device according to claim 25, wherein said unit is functionally positioned on the data path between the WCD's central processing unit (CPU) and the WCD's modem.

27. A device according to claim 25, wherein said unit comprises:
a central processing unit (CPU);
a read only memory (ROM) storing operational codes of said unit;
flash memory for storing said activity data and user identification codes; and
a random access memory for holding intermediate data required for the CPU's operation.

28. A device according to claim 25, wherein said unit comprises of an asymmetric data encryption standard accelerator for boosting performance of public key infrastructure (PKI) and secure connection handshake.

29. A device according to claim 25, wherein said unit comprises a symmetric data encryption standard accelerator.

30. A device according to claim 25, wherein said unit comprises a random key generator.

31. A device according to claim 25, wherein said unit comprises one or more real time clocks to record time and duration of recorded activity.
